(19) United States
(12) Patent Application Publication
(10) Pub. No.: US 2026/0163514 A1
(43) Pub. Date: Jun. 11, 2026

(54) Method for Heating and Cooling a Component

(71) Applicant: ZF Friedrichshafen AG, Friedrichshafen (DE)

(72) Inventors: Stefan Bayer, Arnstein (DE); Matthias Groß, Gerolzhofen (DE); Sebastian Kiesner, Burkardroth (DE)

(21) Appl. No.: 19/182,247

(22) Filed: Apr. 17, 2025

(30) Foreign Application Priority Data
Apr. 17, 2024 (DE) 102024203525.4

(51) Int. Cl. H02P 29/62

(52) U.S. Cl. CPC H02P 29/62

(57) ABSTRACT

A method for heating and cooling a component includes determining a holding time based on a first test duration. The method further includes repeatedly carrying out a method cycle, where the method cycle includes heating the component according to a first temperature gradient to a defined maximum temperature; holding the component at the defined maximum temperature for the holding time; and cooling the component according to a second temperature gradient to a defined minimum temperature, where the defined minimum temperature is lower than the defined maximum temperature.

### CROSS-REFERENCE TO RELATED APPLICATION

The present application is related and has right of priority to German Patent Application No. 10 2018 218 118.7 filed on Oct. 23, 2018, the entirety of which is incorporated by reference for all purposes.

### FIELD OF THE INVENTION

The present invention relates generally to a method for heating and cooling a component.

### BACKGROUND

Methods in which a motor or a component of a motor is heated and cooled are known from the prior art. For example, the entire motor or the component of the motor is subjected to thermal cycling. Such methods are also referred to as Powered Thermal Cycle Endurance (PTCE). Frequently, the motor or a component of the motor must be additionally subjected to high-temperature stressing. Such a method is also referred to as High Temperature Operation Endurance (HTOE).

In general, in a method for heating and cooling components, it is desirable that it be ensured that the components are thermally stressed to a sufficient extent when investigating a certain damage mechanism.

### SUMMARY OF THE INVENTION

The problem addressed by the present invention is therefore that of providing a method with which it is ensured that the components are thermally stressed to a sufficient extent when investigating a certain damage mechanism.

According to a first aspect of the invention, the aforementioned problem is solved by a method intended for heating and cooling a component. The method has the following step: determining a holding time on the basis of a first test duration. In addition, the method has a method cycle which is repeatedly carried out and includes the following steps: heating the component to a defined maximum temperature with a first temperature gradient; holding the temperature of the component at the maximum temperature for the determined holding time; and cooling the component to a defined minimum temperature, which is lower than the maximum temperature, with a second temperature gradient.

The core of the present invention is that the method includes the following step: determining the holding time on the basis of the first test duration, and the method includes the method cycle, which is repeatedly carried out and which includes the following step: holding the temperature of the component at the maximum temperature for the determined holding time. Due to the fact that the holding time is determined on the basis of the first test duration, it is ensured that the component can be stressed to a sufficient extent when investigating a first damage mechanism, which is associated with the first test duration, so that, once the method has been completed, a damage pattern which may be present on the component can be evaluated on the basis of a damage analysis provided for the first damage mechanism. Preferably, the first test duration describes a test duration for which the method cycle must be applied at the least in order to investigate a thermal-mechanical ageing of the component or of at least a portion of the component. Preferably, the first damage mechanism therefore corresponds to the thermal-mechanical ageing of the component or of a portion of the component, in particular of an insulation covering of the component, and can be expressed as material fatigue such as cracks or delamination on the component. Alternatively preferable, the first test duration describes a test duration for which the method cycle must be applied at the least in order to investigate a thermal-chemical ageing of the component or of at least a portion of the component. The first damage mechanism preferably corresponds in this case to the thermal-chemical ageing of the component or of a portion of the component, in particular of an insulation covering of the component, and can be expressed as failure mechanisms based on chemical reactions. For example, in the damage analysis, which can be carried out once the method cycle has ended, the component can be investigated for a possible failure of the component. Preferably, a check can be carried out to determine whether a detected insulation resistance is lower than a defined reference insulation resistance.

In summary, it can therefore be established that it can be ensured using the method according to the invention that the component is thermally stressed to a sufficient extent when investigating a certain damage mechanism.

Preferably, the component includes an electrical conductor and an insulation covering, which at least partially covers the electrical conductor. When the component includes the electrical conductor and the insulating coating, which at least partially covers the electrical conductor, it can be determined, for example, by electrical resistance measurements, whether a detected insulation resistance of the insulation covering is lower than a defined reference insulation resistance. For example, an insulation resistance of the insulation covering can be determined and, when the detected insulation resistance is greater than or equal to the defined reference insulation resistance, it can be concluded that there is no failure of the component. If an insulation resistance of the insulation covering is determined and the detected insulation resistance is less than the defined reference insulation resistance, it can be concluded that there a failure of the component.

In one embodiment, the holding time is determined on the basis of a second test duration. Due to the fact that the holding time is determined on the basis of the second test duration, it is ensured that the component can be stressed to a sufficient extent when investigating a second damage mechanism, which is associated with the second test duration, so that, once the method has been completed, a damage pattern which may be present on the component can be evaluated on the basis of a damage analysis provided for the second damage mechanism. Preferably, the second test duration describes a test duration for which the method cycle must be applied at the least in order to investigate a thermal-chemical ageing of the component or of at least a portion of the component. Preferably, the second damage mechanism therefore corresponds to the thermal-chemical ageing of the component or of a portion of the component, in particular of the insulation covering of the component, and can be expressed as failure mechanisms based on chemical reactions.

Preferably, the holding time is determined on the basis of the first test duration and on the basis of the second test duration, so that the component can be stressed to a sufficient extent both when investigating the first damage mechanism and when investigating the second damage mechanism, so that, once the method has been completed, a damage pattern that may be present on the component can be evaluated both on the basis of a damage analysis provided for the first damage mechanism and on the basis of a damage analysis provided for the second damage mechanism. The method can therefore be carried out such that the component can be stressed to a sufficient extent both when investigating the first damage mechanism and when investigating the second damage mechanism, so that a particularly time-efficient method can be provided, since a separate method for stressing the component for the corresponding damage mechanism does not need to be carried out, in particular, for each damage mechanism, and thus, in particular, the separate methods also do not need to be carried out in succession. Rather, the component can be sufficiently thermally stressed for different damage mechanisms within one method.

In one embodiment, the first test duration is a first function of a holding duration. Due to the fact that the first test duration is a first function of the holding duration, it is ensured that the first test duration can be changed by changing the holding duration, so that the first test duration can be minimized, in particular by suitably selecting the holding duration. This is advantageous, in particular, when the holding duration is limited to a defined range.

In one embodiment, the second test duration is a second function of a holding duration. Due to the fact that the second test duration is a second function of the holding duration, it is ensured that the second test duration can be changed by changing the holding duration, so that the second test duration can be minimized, in particular by suitably selecting the holding duration. This is advantageous, in particular, when the holding duration is limited to a defined range.

In one embodiment, the holding time is determined on the basis of a third function of the first test duration and of the second test duration. Due to the fact that the holding time is determined on the basis of the third function of the first test duration and of the second test duration, it is ensured that the component can be stressed to a sufficient extent both when investigating the first damage mechanism, which is associated with the first test duration, and when investigating the second damage mechanism, which is associated with the second test duration. If the component is stressed to a sufficient extent both when investigating the first damage mechanism, which is associated with the first test duration and when investigating the second damage mechanism, which is associated with the second test duration, it is ensured that, once the method has been completed, a damage pattern that may be present on the component can be evaluated both on the basis of a damage analysis provided for the first damage mechanism and on the basis of a damage analysis provided for the second damage mechanism. Furthermore, due to the fact that the holding time is determined on the basis of the third function of the first test duration and of the second test duration, it can be ensured that the holding time can be determined in a particularly computationally efficient manner, since, for example, the first test duration does not necessarily need to be determined for all holding durations, in particular within a range defined for the holding duration, and/or the second test duration does not necessarily need to be determined for all holding durations, in particular within a range defined for the holding durations.

In one embodiment, the third function is a maximum function. Due to the fact that the third function is a maximum function, it is ensured that the component is stressed to a sufficient extent both when investigating the first damage mechanism, which is associated with the first test duration, and when investigating the second damage mechanism, which is associated with the second test duration. As a result, it is ensured that, once the method has been completed, a damage pattern that may be present on the component can be evaluated both on the basis of a damage analysis provided for the first damage mechanism and on the basis of a damage analysis provided for the second damage mechanism. In particular, due to the fact that the maximum function is applied, it is ensured that the shortest possible test duration is determined for each holding duration, so that the component is stressed to a sufficient extent both when investigating the first damage mechanism, which is associated with the first test duration, and when investigating the second damage mechanism, which is associated with the second test duration.

In one embodiment, the holding time is determined on the basis of the third function such that the determined holding time corresponds to that holding duration in which the third function is minimized over the holding duration. Due to the fact that the holding time is determined on the basis of the third function such that the determined holding time corresponds to that holding duration in which the third function is minimized over the holding duration, it is ensured that the determined holding time is selected such that the shortest possible test duration for carrying out the method according to the invention can be selected, in which the component is stressed to a sufficient extent both when investigating the first damage mechanism, which is associated with the first test duration, and when investigating the second damage mechanism, which is associated with the second test duration.

In one embodiment, the absolute value of the first temperature gradient and the absolute value of the second temperature gradient are identical and the sign of the first temperature gradient and the sign of the second temperature gradient differ. Due to the fact that the absolute value of the first temperature gradient and the absolute value of the second temperature gradient are identical and the sign of the first temperature gradient and the sign of the second temperature gradient differ, it is ensured that the method can be carried out as efficiently as possible, in particular since the number of parameters to be provided for carrying out the method can be kept low.

In one embodiment, the method includes the following step: terminating the execution of the method cycle when the cycle number corresponds to a defined number. Due to the fact that the execution of the method cycle is terminated when the cycle number corresponds to the defined number, it is ensured that the method according to the invention can be carried out for a sufficiently long time but is not carried out beyond a necessary extent, in particular when the defined number is determined on the basis of the maximum temperature, the minimum temperature, the first temperature gradient, the second temperature gradient, the determined holding time, and the determined testing time.

Preferably, the component is a component of a motor. Due to the fact that the component is a component of a motor, the component of the motor can be checked using the method according to the invention.

In one embodiment, the component is a component of a motor and the motor is an electric motor. Due to the fact that the motor is an electric motor, the electric motor or at least the component of the electric motor can be checked using the method according to the invention.

Even though the method steps are described in a certain order, the present invention is not limited to this order. Rather, the individual method steps can be carried out in any reasonable order, in particular also temporally in parallel to one another, at least in sections.

### BRIEF DESCRIPTION OF THE DRAWINGS

Further features, advantages, and possible applications of the present invention can be gathered from the following description of the exemplary embodiments and the figures. All described and/or pictorially represented features form, alone and in any combination, the subject matter of the invention also regardless of their composition in the individual claims or their back references. In addition, identical reference characters in the figures stand for identical or similar objects. In the figures:

FIG. 1 shows a schematic view of a profile of a testing temperature over a run time for one embodiment of a method according to the invention,

FIG. 2 shows a schematic view from which a holding time for the embodiment of the method according to the invention can be determined, and

FIG. 3 shows a schematic view of a method cycle of the embodiment of the method according to the invention.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

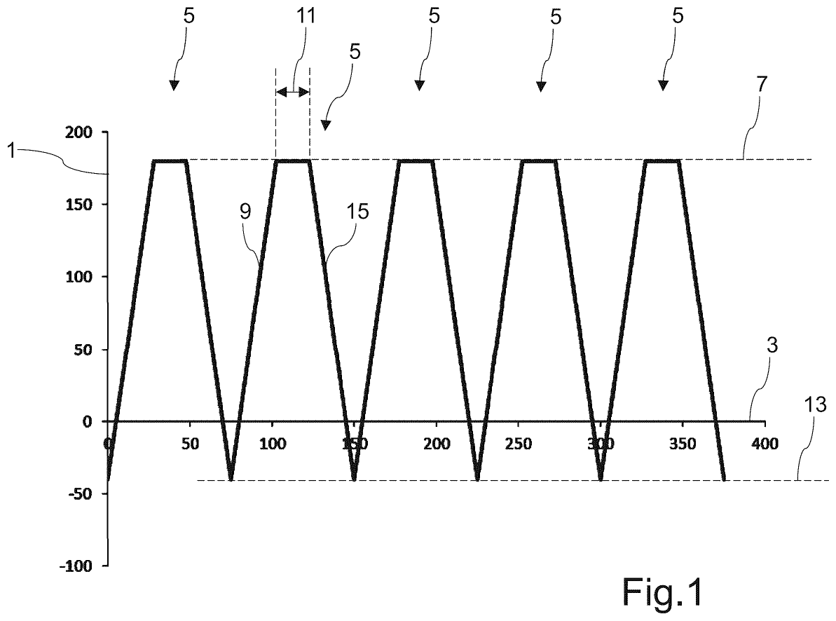

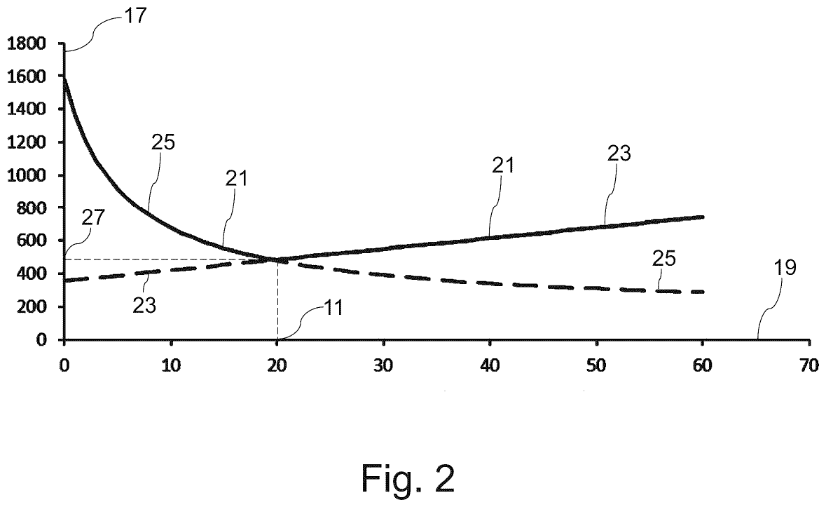

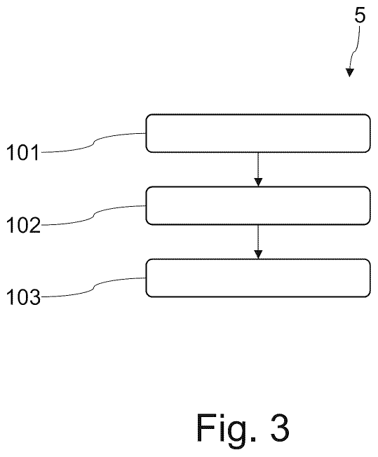

FIG. 1 shows a schematic view of a profile of testing temperature 1 versus run time 3 for an embodiment of a method according to the invention, FIG. 2 shows a schematic view from which a holding time for the embodiment of the method according to the invention is determined, and FIG. 3 shows a schematic view of a method cycle 5 of the embodiment of the method according to the invention. In FIG. 1, the testing temperature 1 is stated or provided in degrees Celsius (° C.) and the run time 3 is stated in minutes (min).

The embodiment of the method according to the invention is intended for heating and cooling a component. The component is a component of a motor. The component includes an electrical conductor and an insulation covering. The insulation covering at least partially covers the electrical conductor. During the method, a holding time is determined. Determining the holding time is described in detail further below. The method also includes a method cycle 5, which is repeatedly carried out once the holding time has been determined and, as shown in FIG. 3, includes a first method step 101, a second method step 102, and a third method step 103.

As shown in FIG. 1, in the first method step 101 of the method cycle 5 from FIG. 3, the component is heated to a defined maximum temperature 7 with a first temperature gradient 9. The defined maximum temperature 7 is stated in ° C. and the first temperature gradient 9 is stated in Kelvin per minute (K/min). The defined maximum temperature 7 is 180° C. and the first temperature gradient 9 is 8 K/min.

As further shown in FIG. 1, in the second method step 102 of the method cycle 5 from FIG. 3, the temperature of the component is held at the maximum temperature 7 for a determined holding time 11. The determined holding time 11 is also stated in minutes (min) and is 20 min. Determining the holding time is described in detail further below.

As shown in FIG. 1, in the third method step 103 of the method cycle 5 from FIG. 3, the component is cooled to a defined minimum temperature 13, which is lower than the maximum temperature 7. The component is cooled to the defined minimum temperature 13 with a second temperature gradient 15. The defined minimum temperature 13 is stated in ° C. and the second temperature gradient 15 is stated in Kelvin per minute (K/min). The defined minimum temperature 13 is −40° C. and the second temperature gradient 15 is −8 K/min.

The method cycle 5 is repeatedly carried out. The first method step 101, the second method step 102, and the third method step 103 are therefore carried out in this order several times in succession. Five method cycles are shown in FIG. 1, 388 method cycles being provided in the method described by way of example.

As described above, FIG. 2 shows a schematic view from which a holding time for the embodiment of the method according to the invention is determined. A test duration 17 with respect to a holding duration 19 is shown in FIG. 2. The test duration 17 is stated in hours (h) and the holding duration 19 is stated in minutes (min).

In the embodiment of the method according to the invention, the holding time is determined as follows; when the holding time is determined, the holding time is referred to as the determined holding time 11. Preferred values for the determined holding time 11 are in an interval from 0 min to 60 min. The determined holding time 11 is represented as H* in the following and satisfies the following equation:

$$P ( {H}^{*} ) = {min}_{H} P ( H ) ,$$

wherein P(H) represents a test duration profile, which is labeled in FIG. 2 with the reference character 21, at a holding duration of H. This means that the determined holding time 11, which is represented as H*, is the holding duration that minimizes the test duration profile P(H).

In the embodiment of the method according to the invention, the test duration profile P(H) is determined as follows.

$$P ( H ) = max ( {P}_{1} ( H ) , {P}_{2} ( H ) ) ,$$

wherein P₁(H) is a first test duration 23, which is labeled in FIG. 2 with the reference character 23 and is stated in hours (h), and P₂(H) is a second test duration 25, which is labeled in FIG. 2 with the reference character 25 and is also stated in hours (h). P(H) is also stated in hours (h).

The following input parameters to be initially determined are used both to determine the first test duration P₁(H) and to determine the second test duration P₂(H).
Tₘₐₓ: maximum temperature in ° C. labeled with reference character 7 in FIG. 1, and is 180° C. in the present example; preferred values for Tₘₐₓ are in an interval from 150° C. to 230° C.
Tₘᵢₙ: minimum temperature in ° C. labeled with reference character 13 in FIG. 1, and is −40° C. in the present example; preferred values for Tₘᵢₙ are in an interval from −40° C. to −20° C.
G: the absolute value of the first temperature gradient in K/min labeled with reference character 9 in FIG. 1, the absolute value of the first temperature gradient corresponding to the absolute value of the second temperature gradient labeled with reference character 15 in FIG. 1, and is 8 K/min in the present example; preferred values for G are in an interval from 5 K/min to 30 K/min
LNₘᵢₙ: minimum advantage factor and is 2.0 in the present example; preferred values for LNₘᵢₙ depend on the defined reliability requirements

The first test duration P₁(H) is determined as follows:

$$\begin{matrix}{P}_{1} ( H ) = \frac{L {N}_{min}}{L {N}_{1}} \times 2 \times ( \frac{{T}_{max} - {T}_{min}}{60 \times G} + \frac{H}{60} ) \\ = \frac{L {N}_{min}}{L {N}_{1}} \times \frac{1}{30} \times ( \frac{{T}_{max} - {T}_{min}}{G} + H ) , \\ = \frac{L {N}_{min}}{30 \times L {N}_{1}} \times H + \frac{L {N}_{min} \times ( {T}_{max} - {T}_{min} )}{30 \times L {N}_{1} \times G}\end{matrix}$$

wherein LN₁ represents a first advantage factor, which is an advantage factor regarding the temperature change load (thermal cycling load) as compared to the field stress or stressing and which is determined as follows:

$$L {N}_{1} = \frac{{S}_{1}}{S {R}_{1}} ,$$

wherein S₁ describes a first damage and is determined as follows:

$${S}_{1} = \frac{1}{{L}_{R}} \times {( \frac{{T}_{max} - {T}_{min}}{Δ {T}_{R}} )}^{CM} ,$$

wherein the following input parameters to be initially determined are used:
SR₁: first damage reference value for load spectrum; 0.0160 in the present example.
L_{R}: reference number for load change; 2540 in the present example.
ΔT_{R}: reference temperature change from the difference between the maximum temperature and the minimum temperature in ° C.; 275° C. in the present example
CM: Coffin-Manson factor; 7.0 in the present example; preferred values for CM are in an interval from 2.0 to 10.0

The second test duration P₂(H) is determined as follows:

$$\begin{matrix}{P}_{2} ( H ) = \frac{L {N}_{min}}{L {N}_{2} ( H )} \times 2 \times ( \frac{{T}_{max} - {T}_{min}}{60 \times G} + \frac{H}{60} ) \\ = \frac{L {N}_{min}}{L {N}_{2} ( H )} \times \frac{1}{30} \times ( \frac{{T}_{max} - {T}_{min}}{G} + H )\end{matrix} ,$$

wherein LN₂(H) represents a second advantage factor, which is an advantage factor regarding ageing as compared to the duty cycle (load histogram) rating or design collective and is determined as follows:

$$L {N}_{2} ( H ) = \frac{{S}_{2} ( H )}{S {R}_{2}} ,$$

wherein S₂(H) describes a second damage and is determined as follows:

$${S}_{2} ( H ) = \frac{H}{{P}_{R}} \times {A}_{2} ,$$

$$with$$

$${A}_{2} = exp [ - \frac{{E}_{A}}{k} \times ( \frac{1}{{T}_{max , K}} - \frac{1}{{T}_{R}} ) ]$$

wherein A₂ represents an acceleration factor and the input parameters that are used are determined as follows:
SR₂: second damage reference value for load spectrum; 0.005 in the present example.
P_{R}: reference dwell time in hours (h); 2000 h in the present example
E_{A}: activation energy in electron volts (eV); 0.7 eV in the present example; preferred values for E_{A} are in an interval from 0.45 eV to 1.0 eV
k: Boltzmann constant in electron volts per Kelvin (eV/K); 0.00008617 eV/K is used in the present example
T_{max,K}: the aforementioned maximum temperature Tₘₐₓ converted to K; 180+273.15 K in the present example
T_{R}: reference temperature in K; 513.15 K in the present example

The holding time is therefore determined on the basis of the first test duration 23. Due to the fact that the holding time is determined on the basis of the first test duration 23, it is ensured that the component is stressed to a sufficient extent when investigating a first damage mechanism, which is associated with the first test duration 23, so that, once the method has been completed, a damage pattern that may be present on the component is evaluable on the basis of a damage analysis provided for the first damage mechanism. In the present example, the first test duration 23 describes a test duration for which the method cycle 5 must be applied at the least in order to investigate a thermal-mechanical ageing of the component or at least of a portion of the component. The first damage mechanism therefore corresponds to the thermal-mechanical ageing of the component or of a portion of the component, in particular of the insulation covering of the component, and is expressible as material fatigue such as cracks or delamination on the component.

In addition, the first test duration 23 is a first function of a holding duration 19. Due to the fact that the first test duration 23 is a first function of a holding duration 19, it is ensured that the first test duration 23 is changeable by changing the holding duration 19, so that the first test duration 23 is minimizable, in particular, by suitably selecting the holding duration 19. This is advantageous, in particular, when the holding duration 19 is limited to a defined range.

The holding time is also determined on the basis of a second test duration 25. Due to the fact that the holding time is determined on the basis of the second test duration 25, it is ensured that the component is stressable to a sufficient extent when investigating a second damage mechanism, which is associated with the second test duration 25, so that, once the method has been completed, a damage pattern that may be present on the component is evaluable on the basis of a damage analysis provided for the second damage mechanism. In the present example, the second test duration 25 describes a test duration for which the method cycle 5 must be applied at the least in order to investigate a thermal-chemical ageing of the component or at least of a portion of the component. The second damage mechanism therefore corresponds to the thermal-chemical ageing of the component or of a portion of the component, in particular of the insulation covering of the component, and is expressible as failure mechanisms based on chemical reactions.

The second test duration 25 is a second function of the holding duration 19. Due to the fact that the second test duration 25 is a second function of the holding duration 19, it is ensured that the second test duration 25 is changeable by changing the holding duration 19, so that the second test duration 25 is minimizable, in particular, by suitably selecting the holding duration 19. This is advantageous, in particular, when the holding duration 19 is limited to a defined range.

The holding time is determined on the basis of a third function of the first test duration 23 and of the second test duration 25. Due to the fact that the holding time is determined on the basis of the third function of the first test duration 23 and of the second test duration 25, it is ensured that the component is stressable to a sufficient extent both when investigating the first damage mechanism, which is associated with the first test duration 23, and when investigating the second damage mechanism, which is associated with the second test duration 25. If the component is stressed to a sufficient extent both when investigating the first damage mechanism, which is associated with the first test duration 23, and when investigating the second damage mechanism, which is associated with the second test duration 25, it is ensured that, once the method has been completed, a damage pattern that may be present on the component is evaluable both on the basis of a damage analysis provided for the first damage mechanism and on the basis of a damage analysis provided for the second damage mechanism. In addition, due to the fact that the holding time is determined on the basis of the third function of the first test duration 23 and of the second test duration 25, it is ensured that the holding time is determined in a particularly computationally efficient manner, since, for example, the first test duration 23 does not necessarily need to be determined for all holding durations, in particular within a range defined for the holding duration 19, and/or the second test duration 25 does not necessarily need to be determined for all holding durations, in particular within a range defined for the holding duration 19.

The third function is a maximum function. Due to the fact that the third function is a maximum function, it is ensured that the component is stressed to a sufficient extent both when investigating the first damage mechanism, which is associated with the first test duration 23, and when investigating the second damage mechanism, which is associated with the second test duration 25. As a result, it is ensured that, once the method has been completed, a damage pattern that may be present on the component is evaluable both on the basis of a damage analysis provided for the first damage mechanism and on the basis of a damage analysis provided for the second damage mechanism. In particular, due to the fact that the maximum function is applied, it is ensured that the shortest possible test duration is determined for each holding duration, so that the component is stressed to a sufficient extent both when investigating the first damage mechanism, which is associated with the first test duration 23, and when investigating the second damage mechanism, which is associated with the second test duration 25.

In addition, the holding time is determined on the basis of the third function such that the determined holding time 11 corresponds to the holding duration at which the third function is minimized over the holding duration 19. Due to the fact that the holding time is determined on the basis of the third function such that the determined holding time 11 corresponds to the holding duration at which the third function is minimized over the holding duration 19, it is ensured that the determined holding time 11 is selected such that the shortest possible test duration is selectable for carrying out the method according to the invention, for which test duration the component is stressed to a sufficient extent both when investigating the first damage mechanism, which is associated with the first test duration 23, and when investigating the second damage mechanism, which is associated with the second test duration 25.

In the method according to the invention, the holding time is therefore determined as described above. The determined holding time 11 is then used to repeatedly carry out the method cycle 5 as described above. Specifically, the component is initially heated to the defined maximum temperature 7 with the first temperature gradient 9, then the temperature of the component is held at the maximum temperature 7 for the determined holding time 11, and, finally, the component is cooled to the defined minimum temperature 13, several times in succession. In the method according to the invention, the holding time is determined prior to the first method step 101, i.e., before the method cycle 5 is carried out for the first time. On the basis of the determined holding time 11, the testing time is then determined, which testing time defines the duration for which the method cycle 5 is repeatedly carried out. When the testing time for which the method cycle 5 is repeatedly carried out has been determined, this testing time is also referred to as the determined testing time 27. The determined testing time 27 corresponds, for example, to the first test duration 23 or to the second test duration 25 or to both the first test duration 23 and the second test duration 25, or also assumes a different value. In the example shown, the determined testing time 27 corresponds both to the first test duration 23 and to the second test duration 25 and is 484 hours. The determined testing time 27 is determined, for example, on the basis of the maximum temperature 7, the minimum temperature 13, the first temperature gradient 9, the second temperature gradient 15, and the determined holding time 11.

The absolute value of the first temperature gradient 9 and the absolute value of the second temperature gradient 15 are identical and the sign of the first temperature gradient 9 and the sign of the second temperature gradient 15 differ. Due to the fact that the absolute value of the first temperature gradient 9 and the absolute value of the second temperature gradient 15 are identical and the sign of the first temperature gradient 9 and the sign of the second temperature gradient 15 differ, it is ensured that the method is carried out as efficiently as possible, in particular since the number of parameters to be provided for carrying out the method is kept low.

The method also includes the following step: terminating the execution of the method cycle 5 when the cycle number corresponds to a defined number. Due to the fact that the execution of the method cycle 5 is terminated when the cycle number corresponds to a defined number, it is ensured that the method according to the invention is carried out for a sufficiently long time but is not carried out beyond a necessary extent, in particular when the defined number is determined on the basis of the maximum temperature 7, the minimum temperature 13, the first temperature gradient 9, the second temperature gradient 15, the determined holding time 11, and the determined testing time 27.

The motor is an electric motor. Due to the fact that the motor is an electric motor, the electric motor or at least the component of the electric motor is checked using the method according to the invention.

Once the repeated execution of the method cycle 5 has been terminated, the component of the motor is investigated for a possible failure of the component. For example, a check is carried out to determine whether a detected insulation resistance is lower than a defined reference insulation resistance. For example, an insulation resistance of the insulation covering is determined and when the detected insulation resistance is greater than or equal to the defined reference insulation resistance, it is concluded that there is no failure of the component. For the case in which an insulation resistance of the insulation covering is determined and the detected insulation resistance is less than the defined reference insulation resistance, it is concluded that there is failure of the component.

In particular, since the component is thermally stressed by the method according to the invention such that two damage mechanisms, specifically the first damage mechanism and the second damage mechanism, are checked at the same time, when the detected insulation resistance is greater than or equal to the defined reference insulation resistance, there is no failure of the component and thus neither a damage pattern which is associated with the first damage mechanism nor a damage pattern which is associated with the second damage mechanism is present. By the method according to the invention, the component is therefore thermally stressed in accordance with multiple damage mechanisms and investigated with respect to these multiple damage mechanisms within one method, so that, by the result of the method according to the invention that there is no failure of the component, it is concluded that two test procedures having different thermal stressings of the component without a failure of the component have been successfully passed.

In addition, when the detected insulation resistance is less than the defined reference insulation resistance, there is a failure of the component and thus either a damage pattern which is associated with the first damage mechanism or a damage pattern which is associated with the second damage mechanism is present, or a damage pattern which is associated both with the first damage mechanism and with the second damage mechanism is present. Using the method according to the invention, the component is therefore thermally stressed in accordance with multiple damage mechanisms and investigated with respect to these multiple damage mechanisms within one method, so that, by the result of the method according to the invention that there is a failure of the component, it is concluded that two test procedures having different thermal stressings of the component with a failure of the component have been successfully passed. Thereafter, an analysis is carried out to determine whether the failure of the component results from the first damage mechanism or from the second damage mechanism or from both the first damage mechanism and the second damage mechanism.

In conjunction with the present invention, a damage pattern is, for example, an embrittlement, a cracking, a loss of strength, or a delamination on a portion of the component. In particular when the component includes an electrical conductor and an insulation covering, and the insulation covering at least partially covers the electrical conductor, a damage pattern is, for example, an embrittlement, a cracking, a loss of strength of the insulation covering, or a delamination of the insulation covering of the electrical conductor. In addition, in conjunction with the present invention, a damage mechanism is understood to mean, for example, a thermal-mechanical ageing of the component or of at least a portion of the component, or a thermal-chemical ageing of the component or of at least a portion of the component.

In addition, it is pointed out that “including” does not rule out other elements or steps and “one” does not rule out a plurality. Moreover, it is pointed out that features that have been described with reference to one of the aforementioned exemplary embodiments can also be utilized in combination with other features of other above-described exemplary embodiments. Reference characters in the claims are not to be considered to be a limitation.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

Reference characters

| | |
|---|---|
| 1 | testing temperature |
| 3 | run time |
| 5 | method cycle |
| 7 | maximum temperature |
| 9 | first temperature gradient |
| 11 | determined holding time |
| 13 | minimum temperature |
| 15 | second temperature gradient |
| 17 | test duration |
| 19 | holding duration |
| 21 | test duration profile |
| 23 | first test duration |
| 25 | second test duration |
| 27 | determined testing time |
| 101 | first method step |
| 102 | second method step |
| 103 | third method step |

1-10. (canceled)

11. A method for heating and cooling a component, comprising:
determining a holding time based on a first test duration (23); and
repeatedly carrying out a method cycle (5), the method cycle (5) comprising:
heating the component according to a first temperature gradient (9) to a defined maximum temperature (7);
holding the component at the defined maximum temperature (7) for the holding time (11); and
cooling the component according to a second temperature gradient (15) to a defined minimum temperature (13), the defined minimum temperature (13) being lower than the defined maximum temperature (7).

12. The method of claim 11, wherein determining the holding time (11) comprises determining the holding time (11) based on a second test duration (25).

13. The method of claim 12, wherein the first test duration (23) is a first function of a holding duration (19).

14. The method of claim 12, wherein the second test duration (25) is a second function of a holding duration (19).

15. The method of claim 12, wherein determining the holding time (11) comprises determining the holding time (11) based on a third function of the first test duration (23) and of the second test duration (25).

16. The method of claim 15, wherein the third function is a maximum function.

17. The method of claim 15, wherein the holding time (11) is determined based on the third function such that the holding time (11) corresponds to a holding duration at which the third function is minimized over the holding duration (19).

18. The method of claim 11, wherein an absolute value of the first temperature gradient (9) and an absolute value of the second temperature gradient (15) are identical and a sign of the first temperature gradient (9) and a sign of the second temperature gradient (15) differ.

19. The method of claim 11, wherein repeatedly carrying out the method cycle (5) comprises repeatedly carrying out the method cycle (5) until a cycle number corresponds to a defined number.

20. The method of claim 11, wherein the component is a component of a motor, and the motor is an electric motor.
